(19) United States
(12) Patent Application Publication
(10) Pub. No.: US 2019/0266853 A1
(43) Pub. Date: Aug. 29, 2019

(54) System and Method of Managing A Free-Play and Return System

(71) Applicant: James Plescia, Sun Valley, CA (US)

(72) Inventor: James Plescia, Sun Valley, CA (US)

(21) Appl. No.: 16/285,198

(22) Filed: Feb. 25, 2019

Related U.S. Application Data
(60) Provisional application No. 62/634,662, filed on Feb. 23, 2018.

(51) Int. Cl. G07F 17/32

(52) U.S. Cl. CPC G07F 17/3297; G07F 17/3251; G07F 17/3255

(57) ABSTRACT

A method of managing a free-play and return system allows a business to provide promotional free access to one or more entertainment kiosks such as an arcade game machine. A plurality of free-play codes is managed by at least one remote server. Each free-play code is designated with either a used or unused status and associated with at least one entertainment kiosk, which is communicably coupled with the remote server and includes a code-reading device. New free-play codes may be generated with a code-generating device and appended into the plurality of free-play codes. An unverified code may be inputted into the code-reading device and is then compared to each free-play code with the remote server in order to identify a matching code from the plurality of free-play codes. If the matching code is found and has the unused status, a no-charge use of the entertainment kiosk is executed.

The current application claims a priority to the U.S. Provisional Patent application Ser. No. 62/634,662 filed on Feb. 23, 2018. The current application is filed on Feb. 25, 2019, whereas Feb. 23, 2019 and Feb. 24, 2019 were on a weekend.

### FIELD OF THE INVENTION

The present invention relates generally to amusement games, kiosks and marketing systems. More particularly, the present invention relates to reward systems used as marketing vehicles.

### BACKGROUND OF THE INVENTION

An arcade game is an entertainment machine typically installed in public businesses such as restaurants, bars and amusement arcades which require payment from the user before playing. Arcade games may include, but are not limited to, video games, pinball machines, electro-mechanical games, redemption games, merchandisers such as claw cranes, air hockey, and billiards. In some areas, some arcade facilities are further permitted to provide gambling machines such as slot machines or pachinko games. Arcade games are typically self-contained units, often housed in a cabinet.

Each round of play for any given arcade machine is typically purchased by the user through inserting one or more coins into a coin slot, upon receipt of which the arcade machine initiates the round of play. In recent years, many arcade machines have been adapted to additionally incorporate payment through magnetized membership cards, credit cards or similar payment methods.

For any business, attracting new customers and encouraging customers to return are fundamental needs of the business; the more customers acquired and retained by the business, the more income that the business earns. Marketing strategies and practices, therefore, are crucial components of any business's operation, as their purpose is to attract and retain customers.

In marketing, promotion refers to any type of marketing communication used to inform or persuade target audiences of the relative merits of a product, service, brand or issue. The aim of promotion is to increase awareness, create interest, generate sales or create brand loyalty. It is one of the basic elements of the market mix, which includes the four P's: Product, Price, Place, Promotion.

One well-known type of promotion is the use of giveaways or freebies, in which items or products (such as access to an arcade game) are given to customers for free in order to attract and/or retain customers, while potentially also increasing sales of complementary goods, such as food and drink sold by the arcade or other business which provided the arcade game for use.

Another well-known marketing strategy is the use of loyalty programs, which specifically identify individual customers in order to deliver various promotional elements directly to the customer as well as to track the customer's activity in some cases, with the ultimate goal of earning more patronage, and therefore money, from the customer. For example, a business may offer a price percentage off coupon to a customer for signing up for the program, or members may be offered a monthly reward such as a free small item or an amount of points assigned to their account which can be used to redeem various rewards, etc.

The present invention, which may also be known as a Free Play & Return System, was developed to work with amusement games, kiosks and marketing systems, primarily as a marketing vehicle. The system was designed to distribute an activation code to customers for free instant credits, additional credits for the customer to accumulate and/or credits to be used on future specific timeframes on the designated game and/or kiosk.

The Free Play & Return System can be presented to customers in a number of different vehicles, such as, but not limited to: a disposable paper card the size of a standard credit card with a magnetic swipe on the back, by a text message, receipt, email, QR Code, etc. The Free Play & Return System's activation code can be redeemed (or entered) by several different means such as an app, a designated website, a text message, by swiping the disposable card or on a designated card system.

Thus, it is the objective of the present invention to provide a system for promoting a business, wherein activation codes are delivered to current or potential customers in order to encourage their patronage. After redemption of the offer code, the customer may continue to interact with the business through an account associated with the activation code, accumulating further rewards in order to further encourage the customer's patronage of the business.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a block diagram illustrating the system of the present invention.

FIG. 2 is an exemplary embodiment of a disposable paper card with a magnetic strip, which is preferably implemented in the present invention.

FIG. 3 is a flowchart illustrating the overall process for the method of the present invention.

FIG. 4 is a flowchart illustrating how the present invention is implemented in different localities.

FIG. 5 is a flowchart illustrating a subprocess of implementing disposable paper cards for the present invention.

FIG. 6 is a flowchart illustrating a subprocess of implementing a credit accumulation account for the present invention.

FIG. 7 is a flowchart illustrating a subprocess of implementing a coupon feature for the present invention.

FIG. 8 is a flowchart illustrating a subprocess of implementing a mystery-prize feature for the present invention.

FIG. 9 is a flowchart illustrating a subprocess of implementing a commodity-dispensing machine for the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

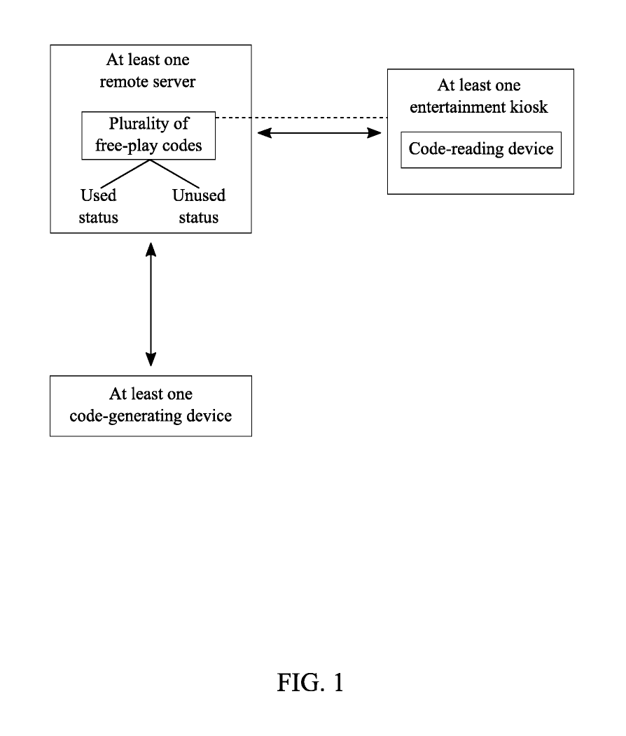

The present invention is a system and a method of managing a free-play and return system, which allows a commercial entity to provide promotional free access to some of their entertainment kiosks. A commercial entity can be, but is not limited to, a grocery store, a retail store, a restaurant, or an arcade. In addition, an entertainment kiosk can be, but is not limited to, a claw-crane game machine, a video game machine, another kind of arcade gaming machine, a video-disc dispensing machine (e.g. Redbox), or a vending machine. As can be seen in FIG. 1, the system of the present invention provides at least one remote server that manages a plurality of free-play codes (Step A). The remote server is used as a hub to exchange information and to relay communications. Each free-play code allows a user to access an entertainment kiosk free of charge. The plurality of free-play codes is associated to at least one entertainment kiosk so that the plurality of free-play codes only give permission to access specific entertainment kiosks free of charge. The entertainment kiosk also needs to be communicable coupled to the remote sever so that the present invention can keep track of an unused status or a used status for each free-play code. The unused status of a free-play code designates that the free-play code has yet to be redeemed at an entertainment kiosk. The used status of a free-play codes designates that the free-play code has already been redeemed at an entertainment kiosk. Furthermore, the entertainment kiosk includes a code-reading device that is able to read and process a free-play code. The code-reading device can be, but is not limited to, a barcode scanner, a magnetic strip reader, or a near field communication (NFC) receiver.

The system of the present invention also provides at least one code-generating device (Step B), which allows a used to create new free-play codes upon the discretion of the commercial entity. For example, if the commercial entity is giving a free-play code to each customer that buys a certain product/service, then the commercial entity will need to meet the demand for free-play codes depending on the number of customers that by the certain product or service. The code-generator device needs to be communicably coupled to the remote server so that the present invention can keep track of the new free-play codes generated by the code-generator device.

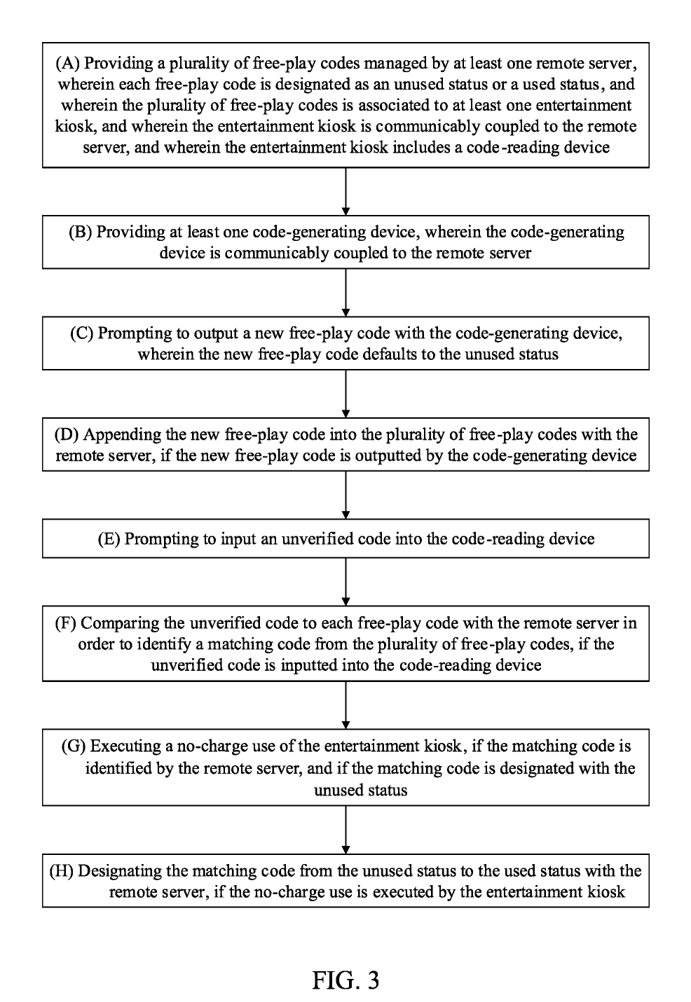

As can be seen in FIG. 3, the overall process followed by the method of the present invention allows a commercial entity to manage and distribute the plurality of free-play codes amongst its customers. The overall process begins by prompting to output a new free-play code with the code-generating device (Step C) so that the commercial entity is readily able to generate a new free-play code. The new free-play code defaults to the unused status. If the new free-play code is outputted by the code-generating device, then the new free-play code is appended into the plurality of free-codes with the remote server (Step D), which allows the remote server to manage the new free-play code in the same way as the existing free-play codes. The overall process continues by prompting to input an unverified code into the code-reading device (Step E) so that a customer is readily able to receive the promotional free access to an entertainment kiosk. The unverified code is some kind of digital input data that has been received by the entertainment kiosk but has not yet been verified by the remote server. Once the unverified code is inputted into the code-reading device, the remote server compares the unverified code to each free-play code in order to identify a matching code from the plurality of free-play codes (Step F). Consequently, if the matching code is identified by the remote server, and if the matching code is designated with the unused status, the overall process continues by executing a no-charge use of the entertainment kiosk (Step G), which provides a customer with the unverified code with their promotional free access to the entertainment kiosk. Once the no-charge use is executed and exhausted by the entertainment kiosk, the overall process concludes by designating the matching code from the unused status to the used status with the remote server (Step H). This prevents a customer from abusively repeating their use of the promotional free access to the entertainment kiosk and consequently prevents the present invention from financially burdening a commercial entity.

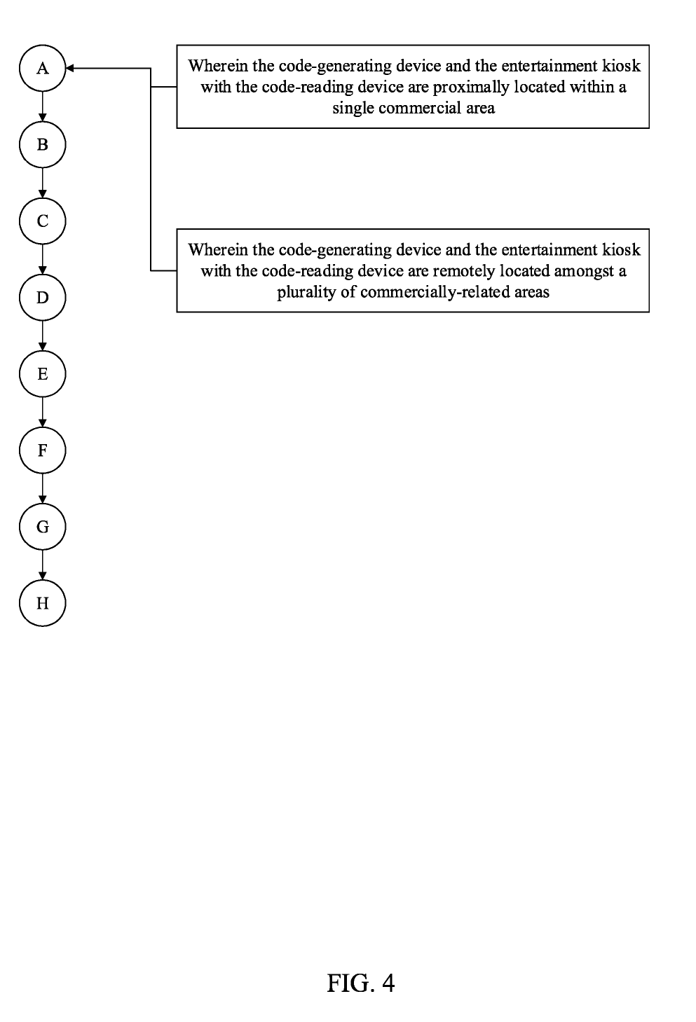

As can be seen in FIG. 4, the commercial entity can implement present invention in a variety of ways in order to improve its financial success. One way to implement the present invention is to have the code-generating device and the entertainment kiosk be proximally located within a single commercial area. For example, the code generating device and the entertainment kiosk can be located within a local grocery store or a local general store in order to promote economic growth for the local grocery store or the local general store within the community. Another way to implement the present invention is to have the code-generating device and the entertainment kiosk be remotely located amongst a plurality of commercially-related areas. For example, the code generating device and the entertainment kiosk can be located through a chain of retail stores in order to promote and grow the brand for the chain of retail stores and to advertise its accessibility through its number of locations.

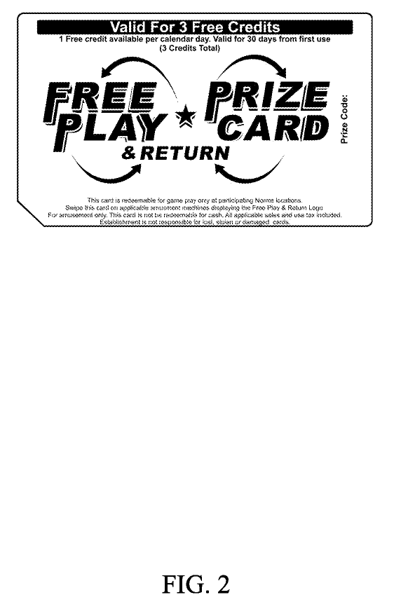

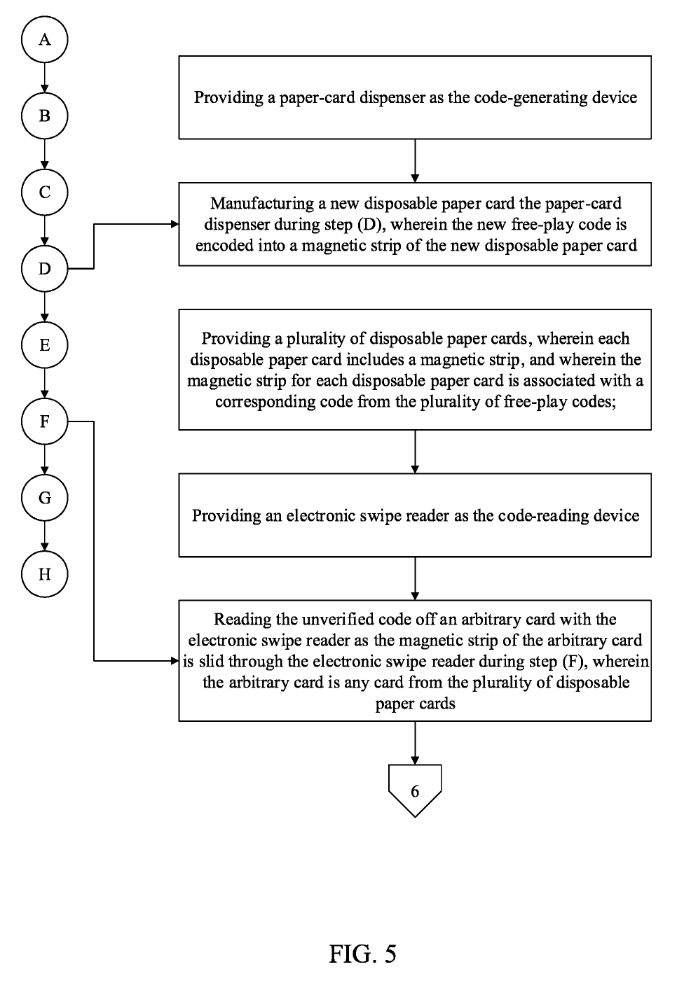

As can be seen in FIG. 5, a preferred embodiment of the present invention implements a plurality of disposable paper cards to disseminate the plurality of free-play codes amongst customers of a commercial entity. More specifically, a magnetic strip for each disposable paper card is associated with a corresponding code from the plurality of free-play codes, which allows the corresponding code to be read or scanned from the magnetic strip. As can be seen in FIG. 2, the plurality of disposable paper cards can be easily manufactured without imposing a significant financial and/or material burden on the commercial entity. Thus, the preferred embodiment of the present invention provides a paper-card dispenser as the code-generating device. The paper-card dispenser is used to manufacture a new disposable paper card during Step D, which can be readily given to a customer of the commercial entity. The new free-play code that is outputted during Step D is encoded into a magnetic strip of the new disposable paper card. In addition, the preferred embodiment of the present invention provides an electronic swipe reader as the code-reading device. The electronic swipe reader is used to read the unverified code off an arbitrary card as the magnetic strip of the arbitrary card is slid through the electronic swipe reader during Step F, which allows a customer to readily receive their promotional free access to the entertainment kiosk. The arbitrary card can be any card from the plurality of disposable paper cards. The electronic swipe reader is preferably configured to received payment information from typical credit cards that have a similar magnetic strip.

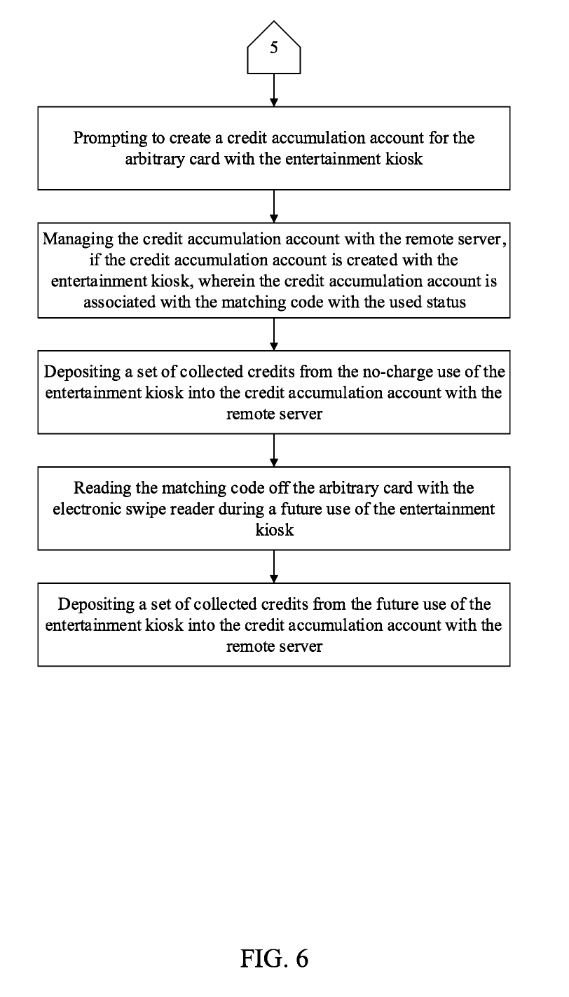

As can be seen in FIG. 6, the present invention may also allow a customer to create a credit accumulation account for the arbitrary card with the entertainment kiosk. The credit accumulation account is used to keep track of the collected credits over multiple used of the entertainment kiosk, which allows a customer to redeem more valuable prizes through their continued use of the entertainment kiosk. Thus, the entertainment kiosk prompts to create a credit accumulation account for the arbitrary card. Once the credit accumulation account is created with the entertainment kiosk, the credit accumulation account is managed by the remote server, which allows the customer to redeem their collected credits at different entertainment kiosks. The credit accumulation account is also associated with the matching code with the used status, which allows the remote server to uniquely identify each customer that accessed the entertainment kiosk. The remote server finally deposits a set of collected credits from the no-charge use of the entertainment kiosk into the credit accumulation account. The set of collected credits can be earned by winning a game hosted by the entertainment kiosk or can be earned by accomplishing some other task on the entertainment kiosk. Later on, the electronic swipe reader would again read the matching code off the arbitrary card during a future use of the entertainment kiosk. The remote server would then deposit a new set of collected credits from the future use of the entertainment kiosk into the credit accumulation account, which allows the customer to continuously save collected credits while using the arbitrary card as a way to identify themselves as the owner of the credit accumulation account.

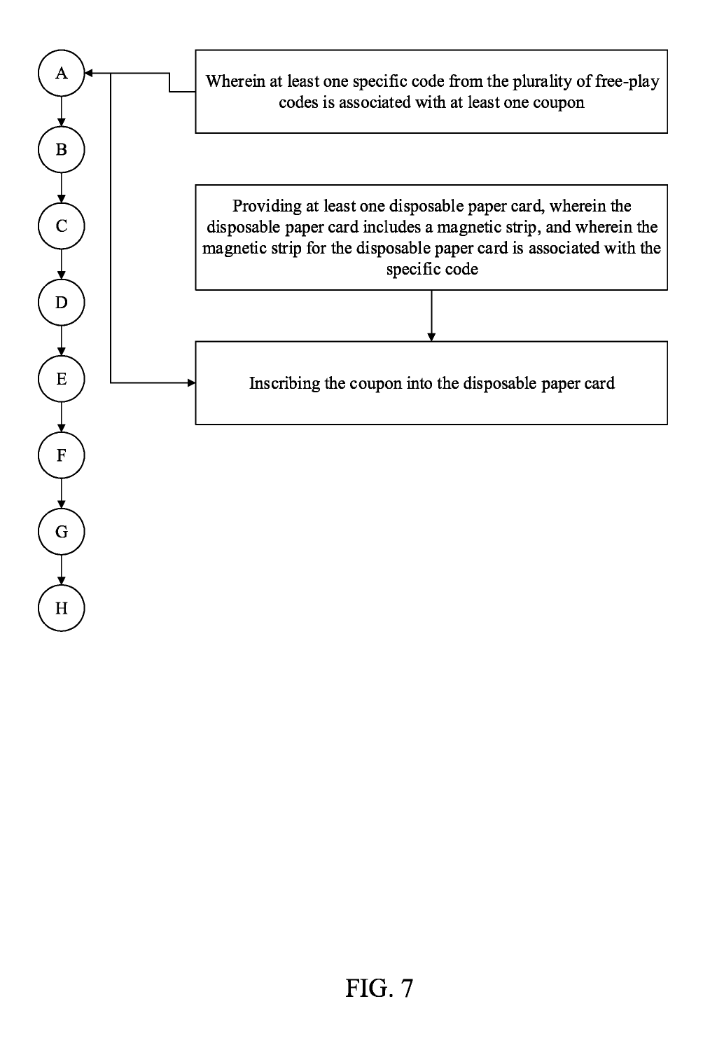

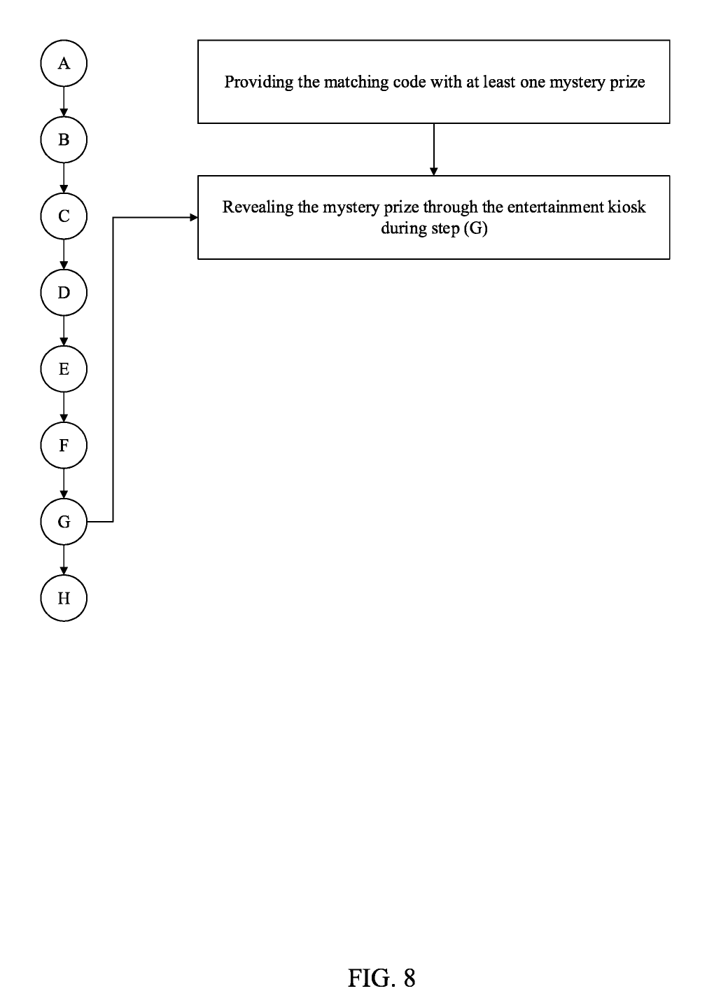

The present invention also allows ancillary promotions through the plurality of free-play codes. One ancillary promotion shown in FIG. 8 is to provide a free-play code with at least one mystery prize. The present invention allows the mystery prize to be given out in a variety of ways, which include, but are not limited to, an enterable code on a website and/or activation of a prize dispenser or locker. If the matching code is associated with at least one mystery prize, then the entertainment kiosk would reveal the mystery prize during Step G. Another ancillary promotion shown in FIG. 7 is to provide a free-play code with at least one coupon, which would preferably allow a customer to receive discounts for products/services sold by the commercial entity. If at least one specific code from the plurality of free-play codes is associated with at least one coupon, and if a magnetic strip for a disposable paper care is associated with the specific free-play code, then the present invention could inscribe the coupon onto the disposable paper card so that the coupon is readily available to a customer with the disposable paper card.

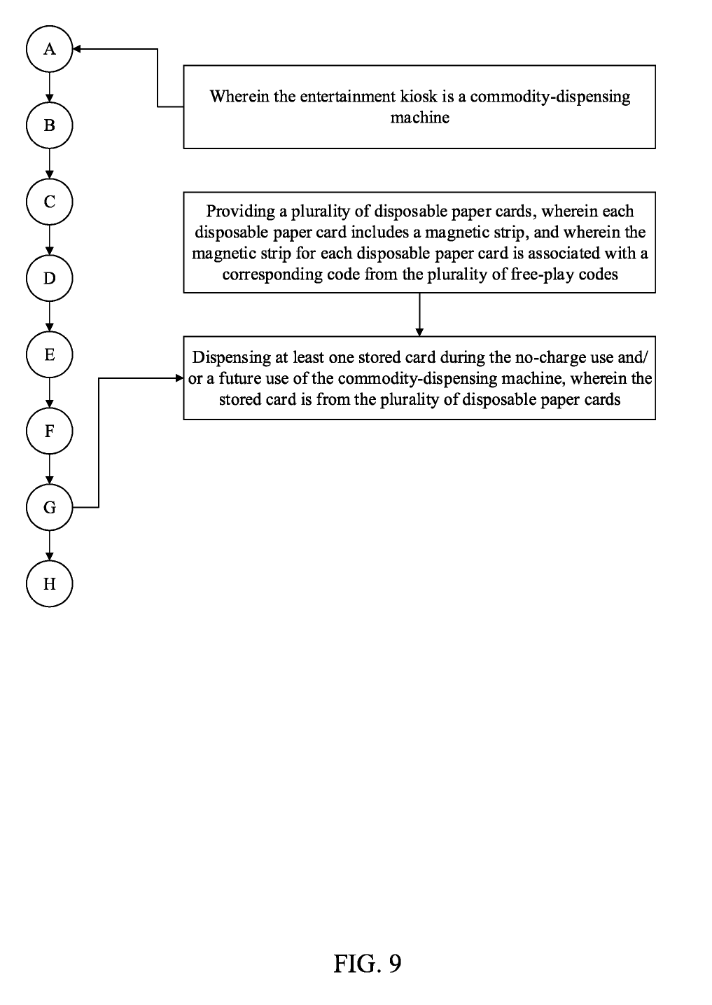

The preferred embodiment of present invention may pair the aforementioned disposable paper cards with a commodity-dispensing machine as the entertainment kiosk, which is shown in FIG. 9. The commodity-dispensing machine is preferably a claw-crane game machine but can also be a video-disc dispenser or a bulk vending machine (e.g. filled with confections, nuts, toys, novelties, and any combination thereof). In preferred embodiment of present invention, the commodity-dispensing vending machine is used to dispense at least one stored card during the no-charge use and/or a future use of the commodity-dispensing machine. The stored card is from the plurality of disposable paper cards and is housed as a prize within the commodity-dispensing machine.

### Supplemental description

The Free Play & Return System can have a number of different functions: The first basic core function of the Free Play & Return System is that it can be given to a customer as a refund. The customer can approach the manager from the location and say they lost their money in whatever game with a Free Play & Return System. The manager askes how much they lost, if the kid says $1, the manager would then give the child a one-time use Free Play & Return Card. The child would then swipe the card on the credit card swipe as if it was a credit card. The card would then activate the game and give the customer one free play on the amusement game. The kid swipes the one-time use card on the already existing credit card swipe. The card activates the machine, in the case of it being only for $1, the machine will only give them show the $1 option. The customer would then be able to play the game for the $1 they lost.

Next Function: The Free Play & Return System, when presented to the customer in the form of a Card, can be programed for when the customer swipes the card on the designated card system, and it would reveal the mystery prize. Mystery prizes can be revealed through the HD monitor on the amusement game. The card could also come with a code that the customer can type into a designated website or application to accumulate or redeem credits. The customer could also be prompted to type or enter a code on the amusement game or kiosk to dispensers or open a prize locker. Next Function: The Free Play & Return System can also advertise discounts or promotions by utilizing the back of the Free Play & Return Card. A coupon code can be printed on the back of the card. The coupon could be for a free small soda, a small basket of fries, 5% off their purchase or anything the locations offers. The coupon could be used on the same day or on their next visit. Certainly, a great draw on the marketing aspect. The coupon could also have a code printed on the card for the customer to go that customer's website and enter the redemption code for a percentage of their purchase. The coupon could guide them to a specific website for them have a coupon emailed to them for them to present to the location on their smart phone device or printed. How the coupon is claimed can be adjusted to fit our client's processes.

Next Function: One of the most powerful marking draws will be the ability to accumulate credits with the Free Play & Return System. The prizes inside the amusement game could have a certain credit value. The customer could win a Free Play Card with a small amount number of credits. They could redeem the credits for a small prize or continue to accumulate credits on their upcoming visits to redeem a larger prize later.

Next Function: This is specific to Impulse Industries' amusement claw crane game that include prize boxes for an instant redemption. By the customer utilizing the Free Play & Return System, they could potentially active the game to open one of the prize boxes to reveal their prize. What makes the Free Play & Return System very unique is that we are utilizing the infrastructure of Impulse Industries' credit card system so we could tie a lot of these functions to a standard Visa/Mastercard/etc. Card to play. As an example, if you swipe your Visa credit card on Impulse's credit card system to play, the game's monitor will reveal “You just won X amount of free plays” and those free plays are then associated to the standard Visa/Master Card. The infrastructure of our system will support the information necessary to tie back those credits to that Visa card.

Differences between Free Play & Return System & a standard “Dave & Busters” card: The Free Play & Return card is very different from the more plastic cards offered in gaming facilities such as Dave & Buster's card where the customer goes to a kiosk and you can fill the card with monies worth of credits and play any machine within that system. What is most different between the plastic Dave & Buster cards and the Free Play & Returns card is that the Dave & Buster's card can only be used within their internal card system. They do not work with the Visa/Master Card system. Therefore, for the customer that does not want to get involved with purchasing the plastic card and loading it with credits, they might only want to play one game, they can use their Visa/Mastercard and use the credits they have already accumulated or begin accumulating credits. Another difference is that it can be programed to be used at any specific location. So, if our customer has a chain of 20 Pizza Restaurants, the card can be programed for all 20 restaurants, only one of the restaurants or only on one specific machine with the credit card system.

How customers can retrieve a Free Play & Return Card: I have only seen these paper type cards used in parking garages and have never been used in the gaming environment. They are very cost effective and could be easily distributed in large quantities. We could create them in the 10s of thousands which makes this a unique concept. The cards could be made available by attaching them on physical prizes. The Free Play & Return Card can be attached directly to a piece of plush. In the case of the capsule vending machines, one card can fit inside a 2″ capsule and it is still functional. The Free Play & Return Card could be mailed to customers in specific mail campaigns. The most effective means would be on perforated mailers where the card is part of a larger mailing piece where the customer would need to tear off the card or peel off the card to allow the customer to come in to the place of business and redeem their prize. The card could also be dispensed via a motorize a card dispensing machine either on the physical amusement game or a self-standing kiosk.

Although the invention has been explained in relation to its preferred embodiment, it is to be understood that many other possible modifications and variations can be made without departing from the spirit and scope of the invention as hereinafter claimed.

What is claimed is:

1. A method of managing a free-play and return system, the method comprises the steps of:
(A) providing a plurality of free-play codes managed by at least one remote server, wherein each free-play code is designated as an unused status or a used status, and wherein the plurality of free-play codes is associated to at least one entertainment kiosk, and wherein the entertainment kiosk is communicably coupled to the remote server, and wherein the entertainment kiosk includes a code-reading device;
(B) providing at least one code-generating device, wherein the code-generating device is communicably coupled to the remote server;
(C) prompting to output a new free-play code with the code-generating device, wherein the new free-play code defaults to the unused status;
(D) appending the new free-play code into the plurality of free-play codes with the remote server, if the new free-play code is outputted by the code-generating device;
(E) prompting to input an unverified code into the code-reading device;
(F) comparing the unverified code to each free-play code with the remote server in order to identify a matching code from the plurality of free-play codes, if the unverified code is inputted into the code-reading device;
(G) executing a no-charge use of the entertainment kiosk, if the matching code is identified by the remote server, and if the matching code is designated with the unused status;
(H) designating the matching code from the unused status to the used status with the remote server, if the no-charge use is executed by the entertainment kiosk;

2. The method of managing a free-play and return system, the method as claimed in claim 1, wherein the code-generating device and the entertainment kiosk with the code-reading device are proximally located within a single commercial area.

3. The method of managing a free-play and return system, the method as claimed in claim 1, wherein the code-generating device and the entertainment kiosk with the code-reading device are remotely located amongst a plurality of commercially-related areas.

4. The method of managing a free-play and return system, the method as claimed in claim 1 comprises the steps of:
providing a paper-card dispenser as the code-generating device;
manufacturing a new disposable paper card with the paper-card dispenser during step (D), wherein the new free-play code is encoded into a magnetic strip of the new disposable paper card;

5. The method of managing a free-play and return system, the method as claimed in claim 1 comprises the steps of:
providing a plurality of disposable paper cards, wherein a magnetic strip for each disposable paper card is associated with a corresponding code from the plurality of free-play codes;
providing an electronic swipe reader as the code-reading device;
reading the unverified code off an arbitrary card with the electronic swipe reader as the magnetic strip of the arbitrary card is slid through the electronic swipe reader during step (F), wherein the arbitrary card is any card from the plurality of disposable paper cards;

6. The method of managing a free-play and return system, the method as claimed in claim 5 comprises the steps of:
prompting to create a credit accumulation account for the arbitrary card with the entertainment kiosk;
managing the credit accumulation account with the remote server, if the credit accumulation account is created with the entertainment kiosk, wherein the credit accumulation account is associated with the matching code with the used status;
depositing a set of collected credits from the no-charge use of the entertainment kiosk into the credit accumulation account with the remote server;

7. The method of managing a free-play and return system, the method as claimed in claim 6 comprises the steps of:
reading the matching code off the arbitrary card with the electronic swipe reader during a future use of the entertainment kiosk;
depositing a new set of collected credits from the future use of the entertainment kiosk into the credit accumulation account with the remote server;

8. The method of managing a free-play and return system, the method as claimed in claim 1 comprises the steps of:
providing the matching code with at least one mystery prize;
revealing the mystery prize through the entertainment kiosk during step (G);

9. The method of managing a free-play and return system, the method as claimed in claim 1, wherein at least one specific free-play code from the plurality of free-play codes is associated with at least one coupon.

10. The method of managing a free-play and return system, the method as claimed in claim 9 comprises the steps of:
providing at least one disposable paper card, wherein a magnetic strip for the disposable paper card is associated with the specific free-play code;
inscribing the coupon onto the disposable paper card;

11. The method of managing a free-play and return system, the method as claimed in claim 1, wherein the entertainment kiosk is a commodity-dispensing machine.

12. The method of managing a free-play and return system, the method as claimed in claim 11 comprises the steps of:
providing a plurality of disposable paper cards, wherein each disposable paper card includes a magnetic strip, and wherein the magnetic strip for each disposable paper card is associated with a corresponding code from the plurality of free-play codes;
dispensing at least one stored card during the no-charge use and/or a future use of the commodity-dispensing machine, wherein the stored card is from the plurality of disposable paper cards;

13. The method of managing a free-play and return system, the method as claimed in claim 11, wherein the commodity-dispensing machine is a claw-crane game machine.
